(19) United States
(12) Patent Application Publication
(10) Pub. No.: US 2018/0147110 A1
(43) Pub. Date: May 31, 2018

(54) SEXUAL INTERACTION DEVICE AND METHOD FOR PROVIDING AN ENHANCED COMPUTER MEDIATED SEXUAL EXPERIENCE TO A USER

(71) Applicant: Tuncay CAKMAK, Herzogenburg (AT)

(72) Inventor: Tuncay CAKMAK, Herzogenburg (AT)

(21) Appl. No.: 15/576,222

(22) PCT Filed: May 23, 2016
(86) PCT No.: PCT/AT2016/050155

§ 371 Date: Nov. 21, 2017

Related U.S. Application Data
(60) Provisional application No. 62/164,964, filed on May 21, 2015.

(51) Int. Cl. A61H 19/00; G06F 3/01

(52) U.S. Cl. CPC A61H 19/32; A61H 19/44; G06F 3/014; A61H 2201/5012; A61H 2201/5043; A61H 2201/5097; A61H 2201/5064; A61H 2201/5079; A61H 2201/5084; A61H 2201/5092; A61H 2201/5048

(57) ABSTRACT

A sexual interaction device for use as an input device for a virtual reality erotic application comprising a body part engaging portion (6, 9, 11, 13, 15) and a distance measurement unit (5). In order to allow for a reliable synchronisation between the user's motion and a virtual environment, it is provided according to the invention that the distance measurement unit (5) comprises an ultrasonic sensor (1) assembly operatively coupled to the body part engaging portion (6, 9, 11, 13, 15).

### FIELD OF THE INVENTION

The present invention relates to a sexual interaction device for use as an input device for a virtual reality erotic application comprising a body part engaging portion and a distance measurement unit.

Moreover, the present invention relates to a method for providing an enhanced computer mediated sexual experience to a user.

### BACKGROUND OF THE INVENTION

For promoting sexual health of men U.S. 2012/0232335 A1 suggests an apparatus and method for promoting ejaculation by human male, since studies correlated a high frequency of ejaculation with a reduced risk of prostate cancer. The apparatus and method include a human interface device and a video display apparatus in communication with and receiving a control signal from the input device. The control signal is generated based on data of a motion sensor in form of an accelerometer. This solution has several disadvantages. For example, absolute distances cannot be measured by means of the accelerometer, which may lead to drifts in the generated signal. Particularly slow motions of the user may thus lead to a significant desynchronization between the user's motions and a video clip or movie displayed by the video display.

U.S. 2006/0079732 A1 discloses a computer-implemented system for providing feedback during sex play using a sensor worn on a user's body part to input motion-dependent signals to a computer during free motion of the body part. The computer accesses a plurality of computer-accessible erotic movie sequences and displays on a display device connected to the computer successive ones of the erotic movie-sequences in accordance with the motion-dependent signals. The sensor sends signals that can be received by a receiver connected to the computer. A distance between sensor and receiver is calculated based on the time to receive successive sensor signals. Since not only a sensor, but also a receiver as well as said calculation are needed to determine a relative position (of the sensor to the receiver), this method is to be regarded cumbersome and thus disadvantageous.

It is thus an object of the invention to provide an apparatus and a method for an enhanced computer mediated sexual experience for promoting sexual health in users, with said apparatus and method overcoming the above-mentioned drawbacks. Particularly, the apparatus and method should be easy to implement, affordable and should allow for an exact and reliable determination of the user's motions, which in turn allows for a reliable synchronisation between the user's motion and a virtual environment. The virtual environment may include erotic movies, animations like a virtual avatar as well as elements (like other virtual characters) with which the user may virtually interact.

### SUMMARY OF THE INVENTION

As specified in the Background Section, above, there is a great need in the art to develop new tools for enhancing and improving human sexual health and computer mediated sexual experiences. Therefore, the following are disclosed:

An apparatus and method for providing sexual stimulation to a user including an input device such as a sexual interaction device (SID) or the like, and a virtual reality display system in communication with, and receiving a control signal from the input device. An input device may include a device useful for engaging the penis of a male user, such as for example, an input device designed to fit around a user's penis and configured for reciprocating movement over the user's penis. The input device further includes a distance sensor and transmitter (wired or wireless). The motion sensor includes at least one ultrasonic sensor module.

An input device may include a device useful for engaging the vagina and/or external genitalia of a female user, such as for example, an input device, having an elongated, generally cylindrical shape, adapted to fit inside the vagina of a user.

The input device further includes a distance sensor and transmitter (wired or wireless). The distance sensor further includes at least one ultrasonic sensor module.

An input device may include an arm engaging device such as a wrist or arm band. The input device further includes a distance sensor and transmitter (wired or wireless). The distance sensor further includes at least one ultrasonic sensor module.

A virtual reality system may include a general purpose computing device or other similar device operatively coupled to a virtual reality head mounted display (HMD). In some cases the virtual reality system is a self-contained device such that the general purpose computing device is integrated into the HMD. In some cases the general purpose computing device is a mobile device (smart phone, tablet or the like) that is capable of engaging an adapter that integrates the mobile device into an HMD. A virtual environment including avatars (human, humanoid, or other forms) is presented to the user by the virtual reality system. The virtual reality environment may be a totally computer generated environment, a video virtual reality environment, or some combination of the two or an augmented reality environment with an virtual object projected into a real environment.

In operation the distance sensor coupled to the input device collects signals (“sensor signals” or “distance measurement data”) relating to the distance between the sensor and a relatively stationary point, such as a relatively still portion of the user's body. Speed of movement of the sensor can also be determined by calculating the rate of change of collected distance measurements. These sensor signals can be transmitted to the virtual reality system and the computing device of the virtual reality system, respectively, by the transmitter. The sensor signals can then be used to control aspects of the virtual environment or interactions in the virtual environment. In this manner the user can use the input device to interact with and or control interactions and/or elements of the virtual environment displayed by the virtual reality system. For example, where the virtual environment is presenting a first person view of a sexual interaction between the user and an avatar, the input device may permit the user to virtually interact with the avatar to facilitate an enhanced sexual experience.

Hence, in a sexual interaction device for use as an input device for a virtual reality erotic application comprising a body part engaging portion and a distance measurement unit according to the invention, it is provided that the distance measurement unit comprises an ultrasonic sensor assembly operatively coupled to the body part engaging portion. In contrast to accelerometers the ultrasonic sensor assembly also allows for the determination of slow motions and of absolute distances without the occurrence of drifts. Compared to Hall sensors the ultrasonic sensor assembly does not rely on an additional source of a magnetic field, i.e. usage of the ultrasonic sensor assembly is less complex and more cost efficient. Moreover, due to the magnetic fields usage of Hall sensors involves additional complications when it comes to obtaining a certification. In comparison with systems working with optical sensors and lasers for determining distances based on e.g. triangulation the ultrasonic sensor assembly allows for much better cost efficiency and is much less error-prone. Compared to an optical distance measurement with markers mounted on the object to be measured—e.g. on a body part of the user—usage of the ultrasonic sensor assembly is much more comfortable, since no markers have to be applied.

In a preferred embodiment of the sexual interaction device according to the present invention, it is provided that the body part engaging portion is a genital engaging portion or an arm engaging portion. As mentioned above, the genital engaging portion can be, e.g. a device designed to fit around a user's penis (the device being part of a female sex doll, for example) or to fit inside a user's vagina (the device being a dildo or part of a male sex doll, for example). In these cases the ultrasonic sensor assembly is essentially used to determine the distance between a part of the genital engaging portion and a part of the user. The arm engaging portion can be, e.g. a device to fit around a user's arm, like a wrist or arm band. In these cases the ultrasonic sensor assembly is essentially used to determine the distance between a part of the user's arm and another part of the user.

In a preferred embodiment of the sexual interaction device according to the present invention, it is provided that the distance measurement unit comprises a mounting member, the mounting member comprising a two-axes rotatable portion. In this way the distance measurement unit can be mounted on an object and the orientation of the distance measurement unit can be adjusted as necessary for a sensible distance measurement, i.e. in a way that the ultrasonic sensor assembly points to the desired part of the user.

Alternatively or additionally, in a preferred embodiment of the sexual interaction device according to the present invention, it is provided that the distance measurement unit comprises a ball joint mounting member. The ball joint mounting member allows for a certain amount of adjustability of the distance measurement unit in all directions.

In a preferred embodiment of the sexual interaction device according to the present invention, it is provided that the mounting member is constructed from a malleable material, preferably of a soft plastic, polysiloxane or rubber. The resulting flexibility of the mounting member facilitates attaching the mounting member at different objects (e.g. sex dolls, dildos, etc.) or body parts of the user (e.g. wrist, arm, waist, leg, etc.).

In a preferred embodiment of the sexual interaction device according to the present invention, it is provided that the distance measurement unit comprises a transmitter. The transmitter is operatively connected to the ultrasonic sensor assembly and is used to transmit sensor signals and distance measurement data, respectively, to a computing device, for example. Preferably, the transmitter uses wireless technology for the transmission process. The transmitter can thus be a Bluetooth transmitter, for example.

In a preferred embodiment of the sexual interaction device according to the present invention, it is provided that the distance measurement unit comprises a unique identification chip with a unique identification number in order to be able to identify each specific distance measurement unit.

Furthermore, according to the invention there is provided a virtual reality system for promoting sexual health in users, the virtual reality system comprising a sexual interaction device according to the invention, the virtual reality system further comprising a computing device for receiving distance measurement data of the distance measurement unit and for controlling aspects of a virtual environment and/or interactions in the virtual environment based on the received distance measurement data. Particularly, the control of aspects of the virtual environment can effect a synchronisation between the user's motion, which is responsible for the measured varying distance, and a video, for example. In this case the virtual reality environment can comprise a video virtual reality environment with a video. The control of interactions in the virtual environment can particularly effect the control of an avatar of the user. It is noteworthy that based on the received distance measurement data aspects of the virtual environment and interactions in the virtual environment can also be controlled simultaneously.

Analogously, according to the invention there is provided a method for providing an enhanced computer mediated sexual experience to a user, comprising the following steps
presenting the user with a virtual reality environment;
accepting input from the user via a sexual interaction device according to the invention; and
using the user's input from the sexual interaction device as a control signal for aspects of the virtual environment and/or interactions in the virtual environment. Preferably, said method is a computer-implemented method.

In a preferred embodiment of the method according to the present invention, it is provided that the virtual reality environment comprises a video virtual reality environment with a video; and in that distance measurement data from the sexual interaction device is used for mapping a distance to certain frames inside of a loop of the video, in order to control which frame of the loop is to be shown to the user in dependence on the distance measurement data. Particularly, this method can be used for synchronising a 180° or 360° virtual reality video with the user's motion, resulting in a particularly immersive experience for the user.

In a preferred embodiment of the method according to the present invention, it is provided that the loop of the video is changed to the next or previous loop if the distance measurement data is above an upper threshold or below a lower threshold. This means that the user has an intuitive control of when to change from one loop to the next or even previous loop, with each loop consisting of a certain number of frames. Preferably, as long as the loop is not changed the frames of the actual loop are repeated periodically forward and backward, in order to avoid a noticeable frame jump after the last frame in one direction is reached. By means of this algorithm the course of the video becomes controllable by the user in an easy manner. Moreover, the video can be combined with a computer-generated animation. For example, the distance measurement data could be used for controlling both the course of the video and motions of an avatar, where the video and the avatar are combined by the computing device.

In a preferred embodiment of the method according to the present invention, it is provided that the method further comprises following steps: receiving a unique identification number from the distance measurement unit, the unique identification number being allocated to a specific distance measurement unit and comparing the unique identification number to a list of unique identification numbers to identify the specific distance measurement unit. By identifying each specific distance measurement unit via its unique identification number, the provider of the method can easily implement access restrictions.

Furthermore, according to the invention there is provided a method for providing an enhanced computer mediated sexual experience to a user, comprising the following steps presenting the user with an augmented reality environment by projecting a virtual object in the person's real environment; accepting input from the user via a sexual interaction device according to the invention; and using the user's input from the sexual interaction device as a control signal for aspects of the augmented reality environment and/or interactions in the augmented reality environment. The advantages of this method are the same as described above.

Analogously, the invention also concerns the use of a distance measurement unit comprising an ultrasonic sensor in a sexual interaction device suitable for use as an input device for a virtual reality and/or augmented reality erotic application.

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### BRIEF DESCRIPTION OF FIGURES

The invention will be explained in closer detail by reference to preferred embodiments, with

FIG. 1 exemplarily showing several embodiments of a sexual interaction device according to the invention

FIG. 2 showing another embodiment of the sexual interaction device

FIG. 3 showing a three-dimensional view and an exploded view of a distance measurement unit of the sexual interaction device

FIG. 4 showing additional views of the distance measurement unit

FIG. 6 showing a flow diagram illustrating various elements of a virtual reality system according to the invention

FIG. 7 showing a flow diagram illustrating the steps of a method according to the present invention

FIG. 8 showing a flow diagram illustrating the steps of initializing the erotic application

FIG. 9 showing a flow diagram for integrating video signal and audio in a virtual reality environment presenting a computer generated sexual experience

FIG. 10 showing a flow diagram for integrating video signal and audio in a virtual reality environment presenting a video mediated sexual experience

FIG. 12 showing a flow diagram illustrating the steps of a method used to present an interactive erotic experience to a user in virtual reality

FIG. 13 showing a flow diagram illustrating the steps of a method used to present an interactive erotic experience to a user in virtual reality

FIG. 14 showing a flow diagram illustrating the steps of a method used to present an interactive erotic experience to a user in virtual reality

FIG. 15 schematically illustrating the architecture of a typical experience using a distance measurement unit enabled input device to control interactions in a virtual reality environment

FIG. 16 showing a diagram illustrating the operation of looped video segments and their interaction with distance measurement unit enabled input devices

FIG. 17 showing a flow diagram illustrating the steps of a method used to present an interactive erotic experience to a user in virtual reality

FIG. 18 showing a series of diagrams illustrating how user interactions with DMU enabled input devices are used to control interactions between a user's avatar and a virtual character present in a virtual environment

FIG. 19 showing diagrams illustrating user interactions with DMU enabled input devices

### WAYS FOR CARRYING OUT THE INVENTION

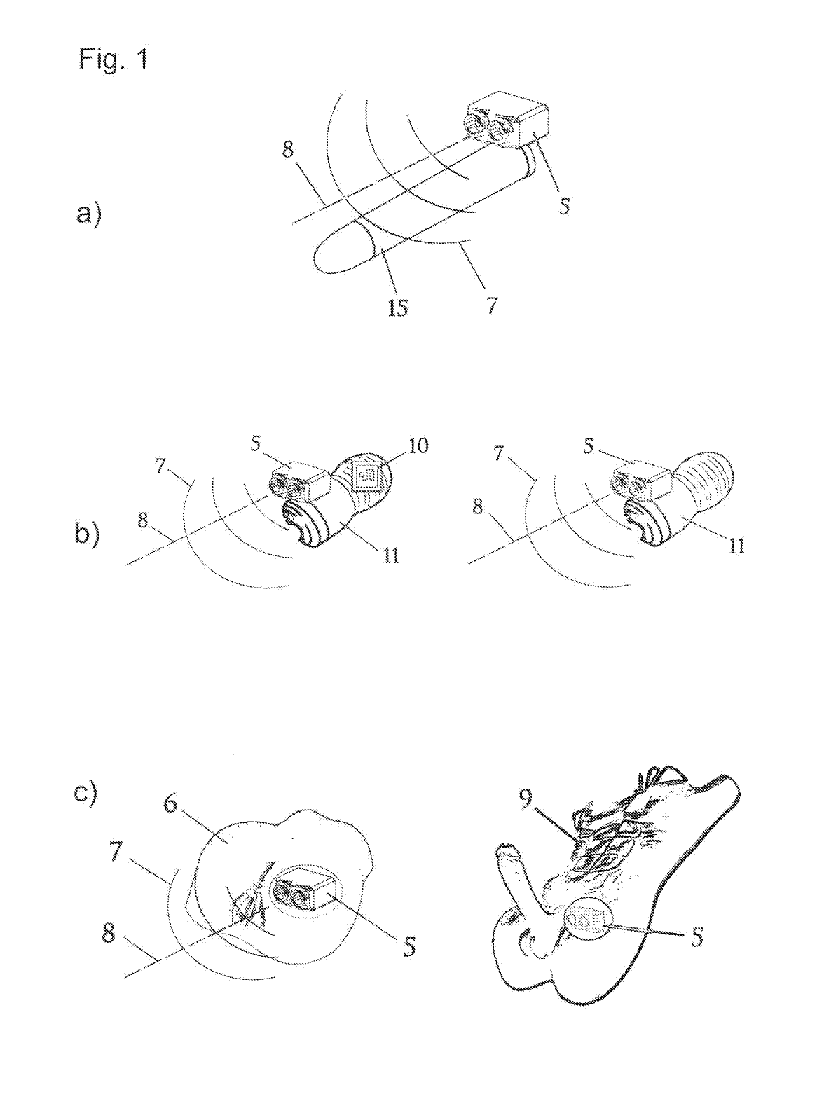

FIG. 1 shows some examples of input devices/sexual interaction devices (SIDs) of the present invention. In some embodiments the SIDs are adapted for use by males/females respectively. FIG. 1 shows in Panel a) a SID adapted for use in engaging the vagina/external genitalia of female users in form of a rubber penis/dildo/vibrator 15. The rubber penis/dildo/vibrator 15 constitutes a body part engaging portion, more particularly a genital engaging portion. The female SID is generally elongated and may be shaped along the general dimensions of a penis.

Middle panel b) of FIG. 1 shows a SID adapted to engage the penis of a male user, of the type disclosed (or similar to) those described in U.S. Pat. Nos. 5,782,818, 6,149,580, the disclosures of which are herein incorporated in their entirety by reference. In this case the body part engaging portion is a genital engaging portion in form of a rubber vagina 11 or so-called masturbator.

In still other embodiments shown in panel c) of FIG. 1, the SID may take the form of a human body/or portion thereof so as to add additional levels of tactile stimulation to users. SIDs taking the form of a human body/or portion thereof may be configured to have male characteristics (the body part engaging portion or genital engaging portion is constituted by male sex doll 9) or female characteristics (the body part engaging portion or genital engaging portion is constituted by a female sex doll 6).

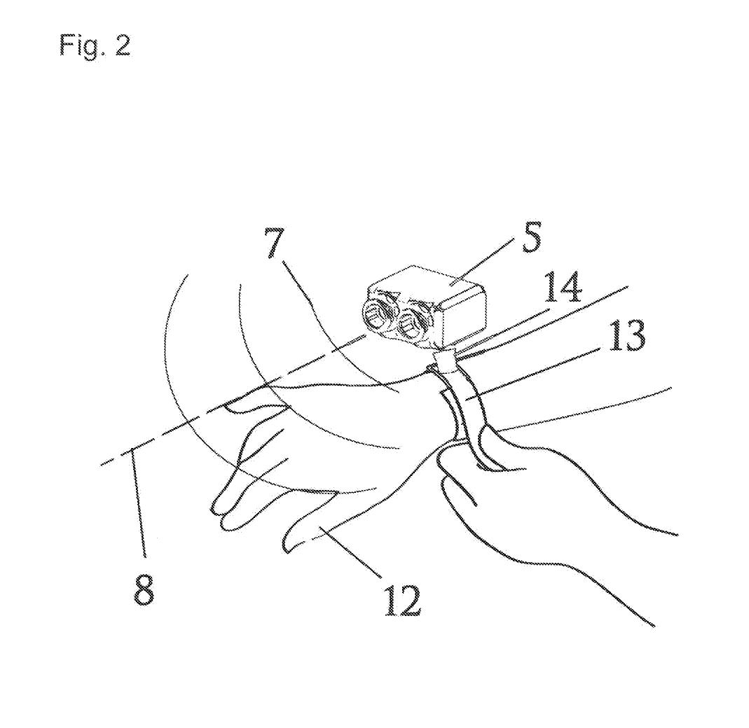

In still other embodiments, such as those shown in FIG. 2 the body part engaging portion of the input device/SID takes the form of an arm or wrist band 13 for being attached to a user's hand or arm 12, i.e. the body part engaging portion is an arm engaging portion in this case.

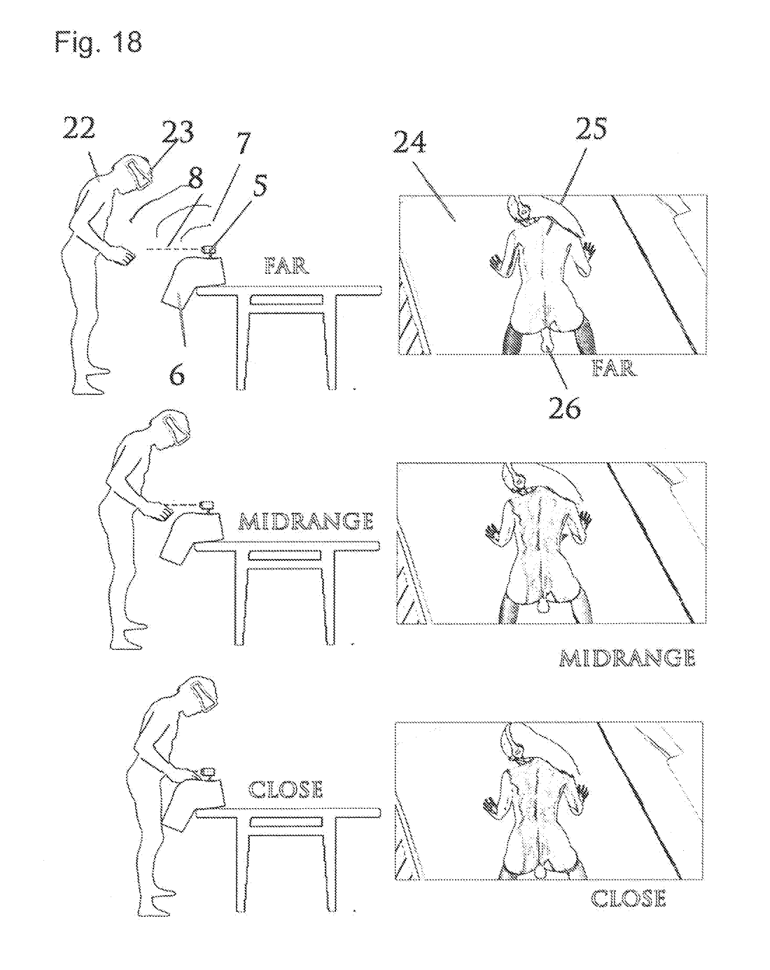

Regardless of the form, the SIDs further comprise a distance measurement unit 5 or sensor to capture data about the relative proximity of the sensor to the user and therein be used to communicate signal data to a virtual reality system for use in interacting and or controlling elements of a virtual environment. In various embodiments, augmented reality (AR) markers 10 are mounted to the input devices. In such embodiments, cameras on an HMD 23 (cf. FIG. 18, for example) used in the virtual reality system detect the marker(s) 10 and be used to project the input devices into the virtual reality environment. In such embodiments the user would be able to see his or her real world environment with the addition of a virtual object, such as a male or female model.

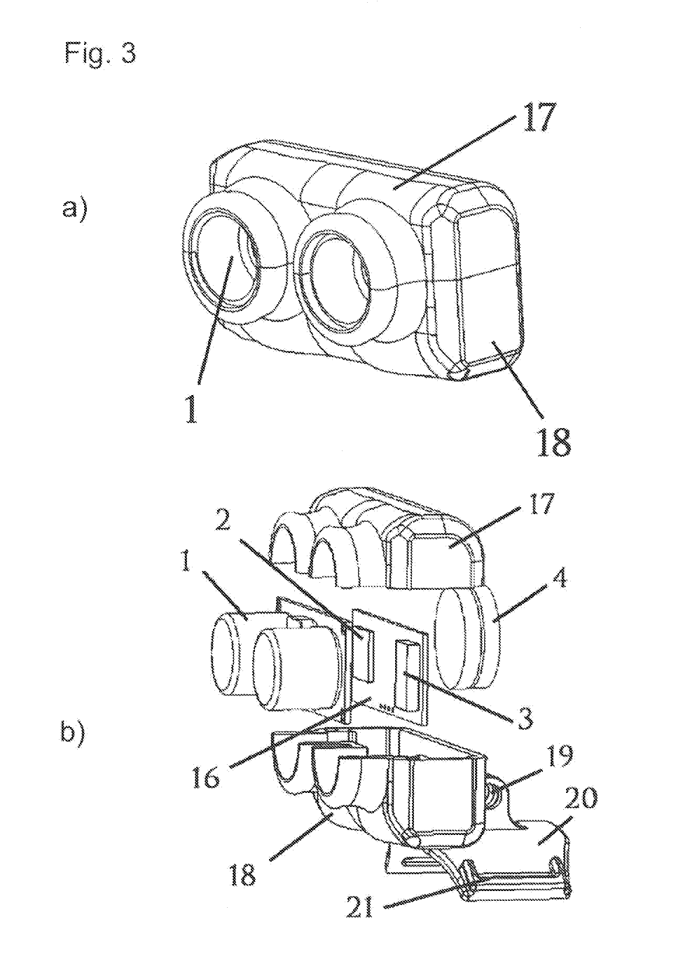

FIG. 3 shows the distance measurement unit 5 in a three-dimensional view in panel a) and in an exploded view in panel b). The distance measurement unit (DMU) 5 collects distance measurement data signals and sends them to the virtual reality system. The DMU 5 generally comprises a case/housing (e.g. with an upper case part 17 and a lower case part 18), a mounting member 20, a battery engaging portion for accommodating a battery 4, a microprocessor 2, a sensor unit and a transmitter 3.

In the embodiment shown in FIG. 3 the mounting member 20 is connected to the housing via a one-axis rotatable joint 19. In contrast to that in the embodiment shown in FIG. 2 the DMU 5 is connected to the wristband 13 via a two-axes rotatable connection 14.

In a preferred embodiment the sensor is an ultrasonic sensor 1. In other embodiments the sensor can be a light sensor/optical sensor or an inertial sensor.

In some embodiments more than one sensor is used in combination.

The sensor can be an acoustic, optical or electrical sensor like a hall sensor. It is also possible to use inertial sensors with magnetometers, gyroscopes and accelerometers as sensors. The advantage of the acoustic, optical or magnetic sensors is the absolute measurement without the so-called drift that can occur with inertial sensors.

The sensor 1 is operatively coupled to a printed circuit board (PCB) 16 which is in turn operatively coupled to the microprocessor 2 and/or a microcontroller. The transmitter 3, such as a Bluetooth transmitter, is operatively coupled to the PCB 16. Bluetooth transmission is particularly useful as it allows the DMU 5 to communicate with computers, tablet computers, smart phones or other Bluetooth compatible devices. The sensor(s) 1 send(s) its signal (analog or digital) to the microprocessor 2/microcontroller which in turn processes the data from the sensor(s) 1 and sends them to the transmitter 3 which in turn transmits the data to a computing device rendering a virtual reality environment.

A power switch, operatively coupled to the PCB 16 and in some embodiments mounted on the housing operates to turn the DMU 5 on and off. Power to the DMU 5 is provided by the battery 4 or other suitable power source. The battery slot could be designed for a 9 volt battery, for two 3 volt batteries or other batteries. It is also possible to use an accumulator which can be recharged.

In some embodiments the housing further comprises or is coupled to the mounting member 20. The mounting member 20 is designed so that the DMU 5 can be mounted on different objects, forms or surfaces. In some embodiments different mounting members 20 may be included so as to allow the DMU 5 to be mounted onto different objects. In some embodiments the mounting member 20 can be connected to the housing with a screw and two-axes rotatable portion. This allows for the adjustment of the DMU 5 in two axes—one normal to the case plane and the other normal to the axis of the first one.

In some embodiments a ball joint mounting member is used to provide additional adjustability.

The mounting member 20 can have a flexible/bendable bottom surface or it can be planar.

In some embodiments the mounting member 20 may be constructed from a malleable material, such as a soft plastic so that it may adjust its form to accommodate the object on which it is to be mounted.

In some embodiments the mounting member may further comprise fixation nodes 21 allowing for the attachment of ropes, rubber bands or hook-and-loop connectors.

In some embodiments a rotational joint of a forked construction is implemented. In such embodiments, the housing or the mounting member has three planes and the opposite part has two planes. The two planes of one part fit exactly inside the three planes of the opposite part. There may be holes in every plane where a screw can fit through. Tightening the screw leads to a higher friction between the planes and can be used to adjust the ease with which the DMU's 5 position can be adjusted.

In some embodiments DMUs 5 are each associated with a unique ID number. A pool of ID numbers created by an algorithm is available to assign a unique ID number for each DMU 5. The ID number assigned to each DMU 5 is stored in the memory of the microcontroller.

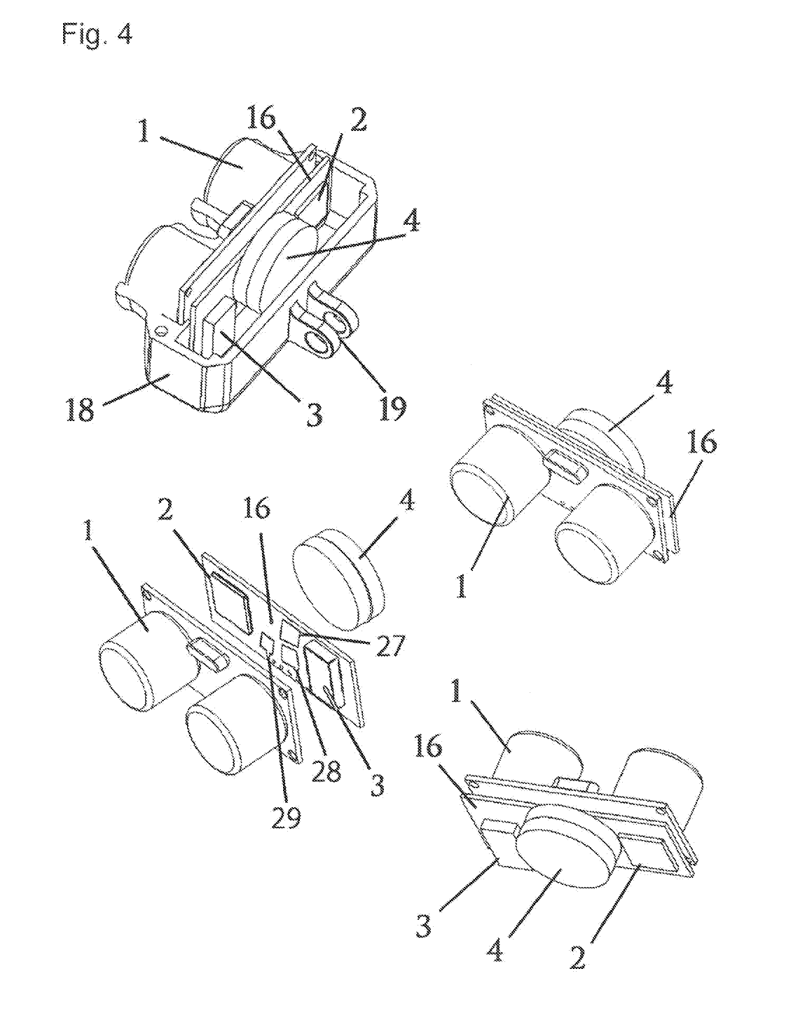

FIG. 4 shows additional views of the DMU 5 showing the assembly of the housing, the PCB 16, the microprocessor 2, the transmitter 3, the sensor 1, and the battery 4.

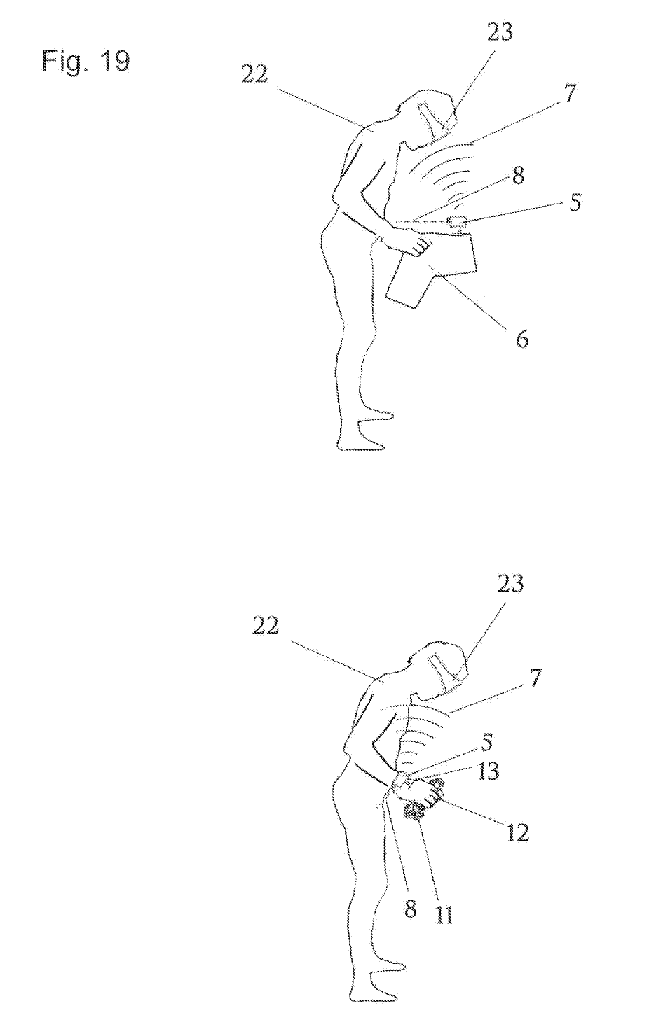

In use the DMU coupled input devices are used to deliver an enhanced computer mediated sexual experience by communicating and providing a control signal to an erotic application 24 (cf. FIG. 18) running on a computing device. The DMU 5 coupled to the input device measures the absolute distance between the sensor 1 and the user's body (by means of ultrasonic waves, cf. e.g. FIG. 1) to synchronize the position of the virtual models. The measurement can for example be at the leg or at the stomach of the user 22 (cf. FIGS. 18, 19) or even at another object on the user 22.

The DMU 5 provides a control signal to allow for the control/synchronization of the user's hand, body or input device with a virtual model or animation in a virtual environment so as to present to the user 22 the illusion that he or she is actually having an interactive sexual experience with a virtual model 25 (cf. FIG. 18). Because accurate synchronization between what the user 22 feels and what the user sees is so important, the invention of the present disclosure has advantages over the prior art in that it delivers an extremely low latency, stable, and easy to use interface. It also has the advantage of being an economical solution in that it can be used with mobile-based HMD solutions.

After the Virtual Reality Erotic Application 24 is installed on the computing device, the user 22 can start the application 24. The user 22 then activates the DMU 5 and connects it via

Bluetooth or other modality to the computing device. The camera system of the user 22 inside the virtual environment is controlled by the sensors inside the Smartphone or the HMD 23 he/she is using. That allows the user 22 to look around with his head inside of the virtual reality application 24 (Camera

Controller HMD). The user 22 can look at virtual buttons to activate different actions inside the application (Input Controller HMD). For instance changing positions, changing virtual partners 25, controlling the sound etc. (Audio Controller or Input Controller with HMD).

The virtual body 26 of the user 22 can be animated by the sensor data of the HMD 23. For example if the user 22 looks to the left, the virtual head of the user 22 will also look to left and follows the head movements (Animation controller HMD).

The sensor data of the DMU 5 is also used to control the animation of the virtual characters 25, 26 (Animation Controller DMU). When the user 22 changes the distance of his body to the sensor 1 or he moves the sensor 1 so that the distance to his body gets changed, then the virtual characters 25, 26 will animate in response to the signal provided by the sensor(s) 1. The sensor 1 measures the distance of an object with ultrasonic signals and can calculate the distance with a precision of a few mm.

In the application 24 a maximum distance and a minimum distance can be configured. If the user 22 moves the sensor 1 and reaches the maximum distance or more a variable in percent can be set to 0 or other desired lower limit. If the user 22 moves the sensor 1 and reaches the minimum distance or less a variable can be set to 100 or other desired upper limit. All the distances between the maximum and the minimum get calculated into a number between 0 and 100 regarding the position of the distance. The variable between 0 and 100 can be used to control the animation of the virtual characters 25, 26. Every change of the distance between the borders will change the variable and also change the animation of the virtual characters 25, 26.

Certain distances of the sensor can also be used for actions inside the virtual reality application. For example the distance 0 or other desired distance, can cause an action inside the virtual environment, so the user 22 only has to hold his hand directly in front of the sensor 1 to get the data 0 mm (Input Controller DMU).

An inertial sensor can be used additionally to the ultrasonic sensor to enhance the precision or also allow for other motion tracking. With the addition of an inertial sensor to the DMU 5, it is possible to use data from sensors like accelerometers 27, gyroscopes 29, magnetometers 28 and the like, cf. FIG. 4. With this additional data it is possible to detect more precise motions and use them as control signals to interact with the virtual world. This motion data can be used to control the virtual character 26 along additional axes, not just a linear axis. It is also possible to use this data to activate different actions in the virtual reality application 24 and/or use the movements of the sensor 1 for different gestures. For example, if the sensor 1 is attached with a wristband 13, the user 22 could also make gestures like waving in the virtual world. Additionally, shaking the input device coupled to the DMU 5 can be used for different actions, such as, for example playing certain sounds.

In some embodiments user gestures and/or voice commands can be used to control interactions inside the virtual environment. Voice commands are captured with a microphone that may be coupled to the HMD 23 or part of the mobile device that is incorporated into the HMD 23 by the adapter. External microphones may also be used. The sensor system inside the HMD 23 or the mobile device inside of the HMD 23, head gestures (such as shaking of the head, and/or nodding) may be captured and used as control signals. For example an up/down nodding may be used to indicate “yes” where a left/right nodding can be used to indicate “no”.

To calibrate the camera in the virtual environment it is possible that the user 22 looks at a virtual button or just a certain degree to the top. Or he can tap the HMD 23 and use the accelerometers to reset the camera position inside the virtual reality scene.

The user can also use the DMU 5 to calibrate the camera, for example distance 0 can calibrate the head camera.

After the Virtual Reality 180/360 degree Video Erotic Application 24 is installed on the computing device, the user 22 can start the application 24. The user 22 has to activate the DMU 5 and connect it via Bluetooth or other transmission modality to the computing device. The camera system of the user 22 inside the virtual environment is controlled by the sensors inside the Smartphone or the HMD he/she is using. That allows the user to look around with his/her head inside of the virtual reality application (Camera Controller HMD). In some embodiments, the camera system is placed inside a sphere on which a movie, or frames of a movie are displayed. The user 22 can now look around and see a real environment which was recorded with 180 or 360 degree virtual reality cameras. The user 22 can look at virtual buttons inside of the texture sphere or otherwise projected into the user's field of view to activate different actions inside the application (Input Controller HMD). For instance changing to different scenes or frames, or activating different sounds etc. (Input Controller or Audio Controller HMD). For example if the user 22 looks to the left, the user 22 will also look to left part of the frames on the sphere (Camera controller HMD). The sensor data of the DMU 5 is used to control the frames/frame rates of the movies or the pictures on the sphere (Frame Controller DMU). When the user 22 changes the distance of his body to the sensor 1 or he moves the sensor 1 so that the distance to his body gets changed, then the frames will change. The sensor 1 measures the distance of an object with ultrasonic signals and can calculate the distance with a precision of a few mm. The distance data can be mapped to certain frames of the video or to certain frames inside of a loop in the video. In the application 24 a maximum distance and a minimum distance can be configured. If the user now moves the sensor 1 and reaches the maximum distance or more a variable in percent can be set to for example 0. If the user moves the sensor 1 and reaches the minimum distance or less a variable can be set to for example 100. All the distances between the maximum and the minimum gets calculated into a number between 0 and 100 regarding the position of the distance. The variable between 0 and 100 can be used to control which frame of the loop or the video should be shown at the sphere. If a certain percent gets achieved for example 90%, the loop of the video will change to the next loop. If the certain maximum percent does not get achieved and the user 22 moves his body back again from the sensor 1, the video will be played reversed. Every change of the distance between the borders will change the variable and also change the frame shown at the sphere texture.

Certain distances of the sensor can also be used for actions inside the virtual reality video application. For instance distance 0 may cause an action inside the virtual environment, so the user 22 only have to hold his hand directly in front of the sensor 1 to get the data 0 mm (Input Controller DMU). This action could be for example, changing the loops inside of the video. An inertial sensor can be used in addition to the ultrasonic sensor 1 to enhance the precision or also allow for other motion tracking.

The movie has to be prepared to use it inside the virtual application 24. To prepare the video, it is possible to use algorithms which insert additional frames between the existing frames to make the video play more smoothly when run in slow motion. In other embodiments, various still images may be taken from the video for use within the virtual reality application. In some embodiments video textures may be implemented and controlled with scripts. When the distance data changes, the frames shown will be frames from a loop part of the movie, if the user acts inside of borders of the distances, the movie parts will be shown forward and backward until he reaches the border. When he reaches the border of the distance then the loop will change to the next movie part. With this system the user 22 can get a very immersive virtual reality movie experience with different scenes of the erotic movie. It is also possible that when the user 22 reaches the last loop of the movie that the whole system will get reversed so that the movie plays backwards until the user 22 reaches the first loop of the movie. This allows for a smooth experience without a frame jump inside the movie experience at the last frame.

Various systems of the present disclosure will also include software libraries, applications and algorithms such as, for example:

Library 1: The software library allows developers to integrate the DMU 5 enabled devices into their applications with less effort. The library handles the communication of the signals coming over Bluetooth from the DMU enabled devices into the application and calculates the distance data into a percentage data from 0 to 100 between the maximum distance and minimum distance border. These borders can be configured by the developer of the application or also can be changed by the user 22 of the application. It is also possible to activate the DMU 5 with certain commands, send to the DMU 5 over Bluetooth or call the same functions on the DMU 5 microcontroller with commands.

Library 2: Another library allows developers to integrate the login system of the erotic application database into their applications. The login system sends, after the login process, a signal to the DMU enabled device and asks for the unique ID of the device. After receiving the ID from the device the login system sends it to the erotic application database to make a check to see if the device is not a copied device. The database has a pool of IDs generated with an algorithm and every device has an ID number of that pool.

It is possible to combine the two libraries into one library so the developers have an easier time integrating the devices and the login system into their applications.

Store Application: The store application allows users to search for applications which are able to use with the DMU enabled devices and to buy them. When the users are logged in they can buy an application and activate the download. When a user buys an application a variable gets saved at the user database and allows the user to download the application. Developers can put their application on a central application database and can sell them over the store application.

Algorithm A: It is possible to filter incoming distance data to smooth the motion curve. For example you can store old data into a variable and compare the next coming data and if the absolute difference is too big, you can correct the new data.

Algorithm B: The curve of the incoming distance data can be analyzed and with an algorithm the maximum and minimum of the curves can be detected. It is also possible to detect the frequency of the curve of the motion data. With the frequency it is possible to calculate a shift to the animation of the virtual characters to compensate the latency at higher frequency motions.

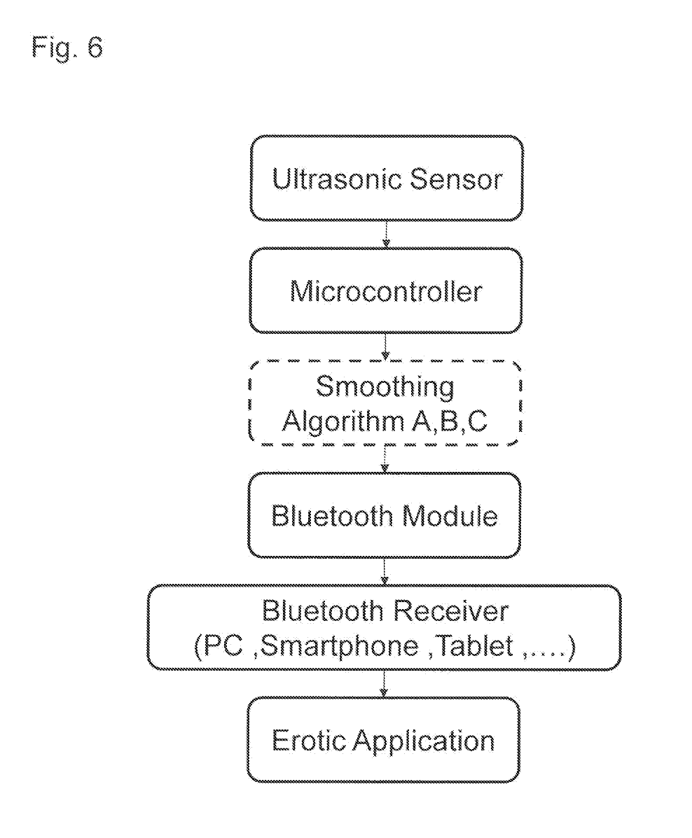

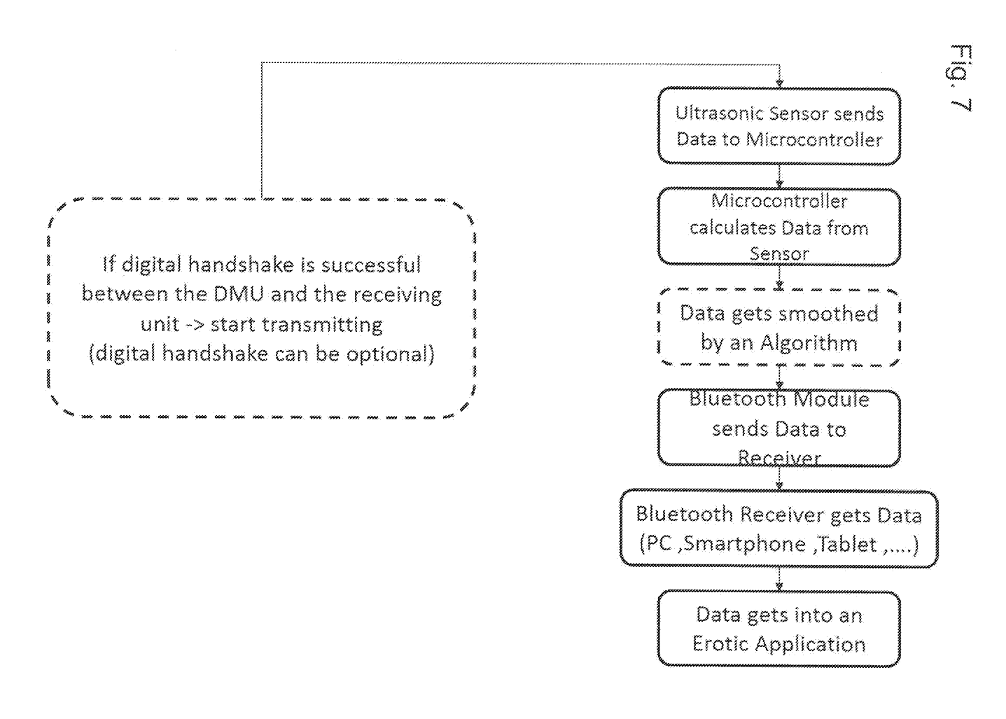

FIG. 6 shows a flow diagram illustrating the various elements of a system of the present invention and how they are operatively connected. An ultrasonic sensor 1 on the DMU 5 is operatively connected to a microcontroller, which is in turn connected to a transmitter 3, in this embodiment a Bluetooth module. The transmitter 3 sends a data signal (by means of electromagnetic waves 7, cf. e.g. FIG. 1) to a receiver on a computing device such as a PC, smart phone, tablet or the like. Once received by the computing device, the data signal is used as a control signal to control aspects of an erotic application.

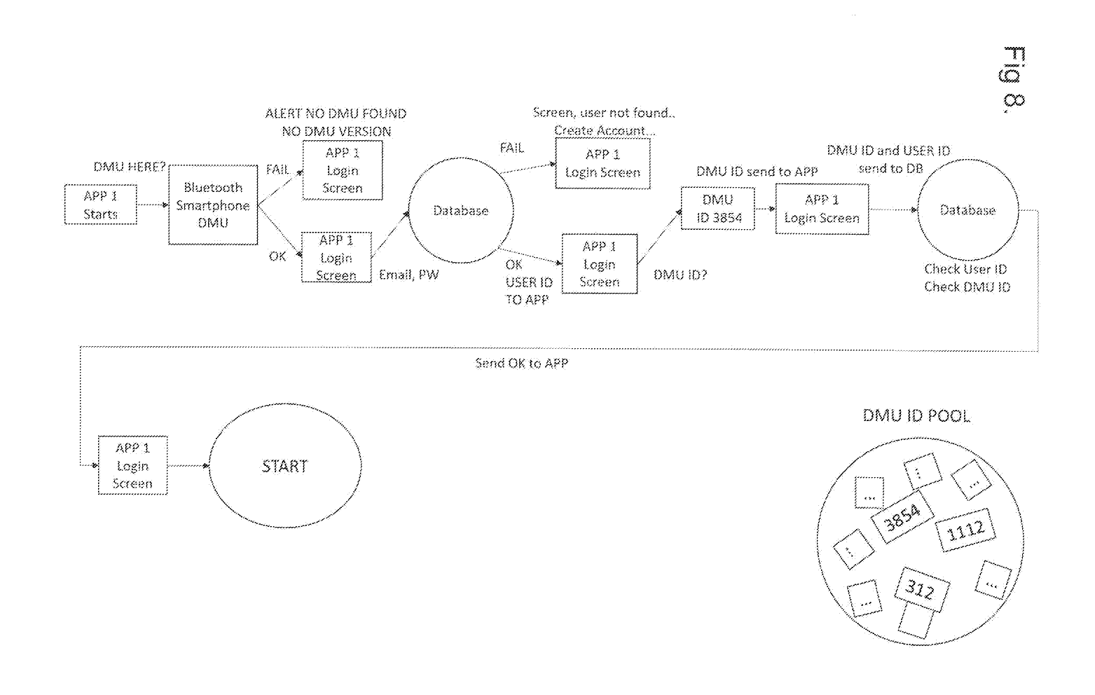

FIG. 7 shows a flow diagram illustrating the steps of a method of the present invention. The ultrasonic sensor 1 sends its collected signal data to the microcontroller of the DMU 5. The microcontroller then calculates and processes the sensor data. In some embodiments the data is smoothed algorithmically to clean up the signal. The data is then transmitted by the transmitter 3 (Bluetooth transmitter) to a receiver on the computing device rendering the virtual environment. Once received the sensor signal data is used as a control signal in a computer mediated erotic application 24.

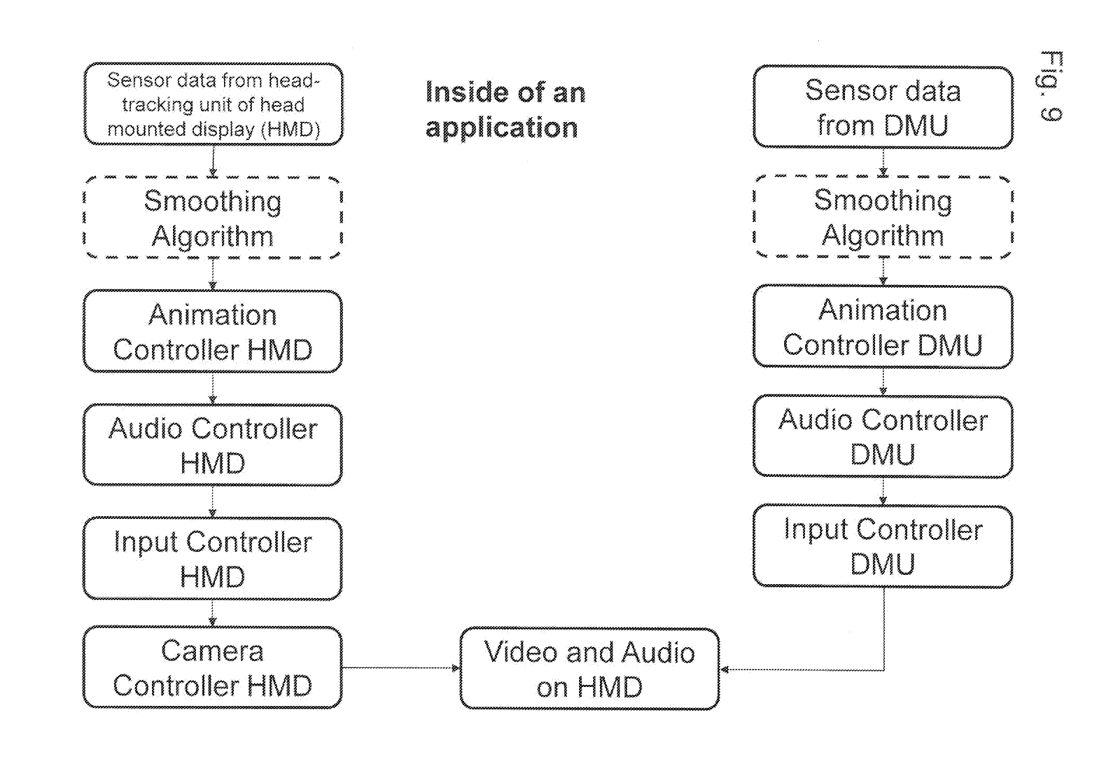

FIG. 8 shows a flow diagram illustrating the steps of initializing the erotic application 24.

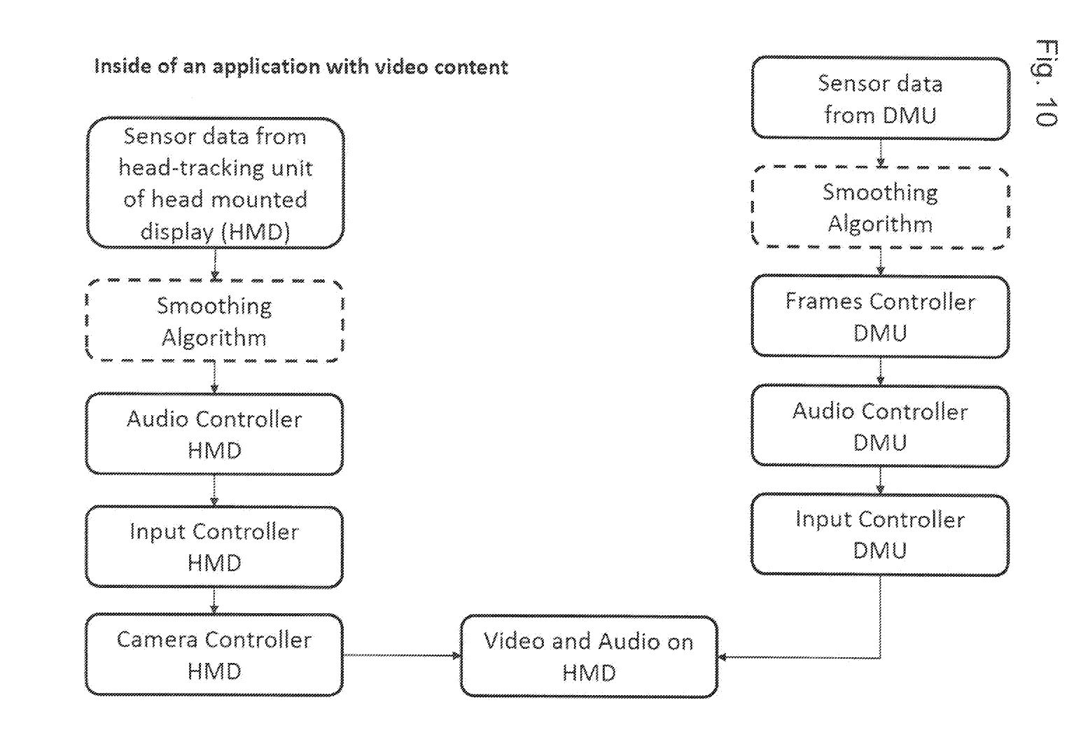

FIG. 9 shows a flow diagram for integrating video signal and audio in a virtual reality environment presenting a computer generated sexual experience. One path integrates HMD sensor data and one path integrates signal data from the DMU enabled input devices. Sensor data from the HMD captures head tracking data; the head tracking data may then be put through a smoothing algorithm; the head tracking data is then used to control a character animation controller in the virtual environment; the head tracking data is also used to control an audio controller; additional input data from the HMD is used as an input controller; head tracking data from the HMD is also used to provide control signals for a virtual reality camera controller; this data is collectively used to present virtual reality video and audio to the user on an HMD. In parallel, data is collected from a DMU enabled input device; the data may be put through one or more smoothing algorithms, the data from the input device is used to provide a control signal for animations within the virtual environment; the data from the input device is also used as an audio controller to provide control signals for audio within the virtual environment; the data from the input device is also used as an input controller within the virtual environment. The result is an immersive virtual reality experience where users motions are captured by the DMU enabled input devices(s) and used to control simulated interactions within the virtual environment.

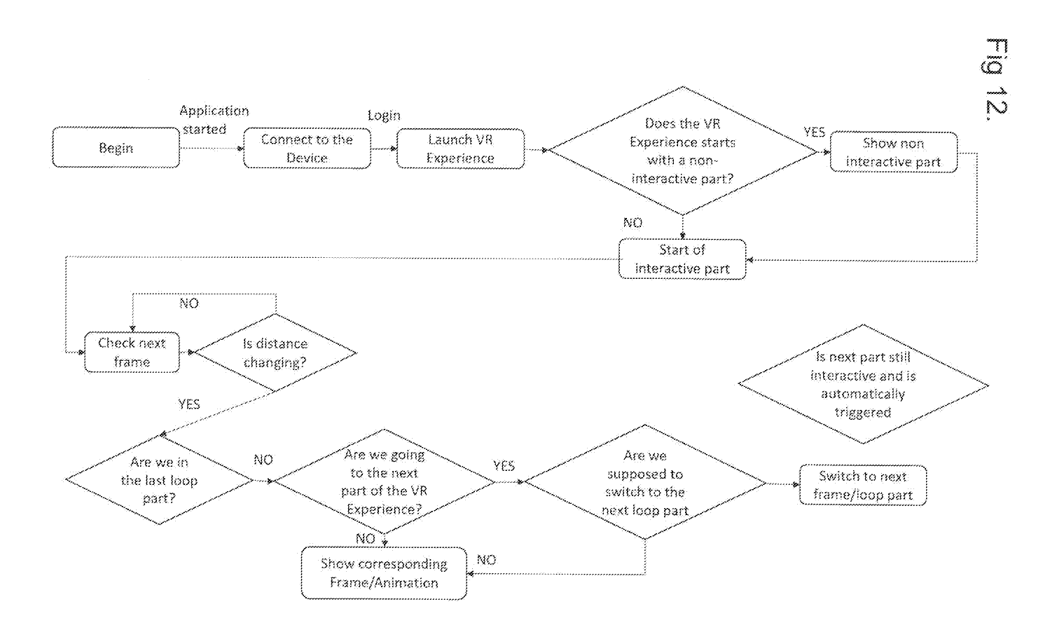

FIG. 10 shows a flow diagram for integrating video signal and audio in a virtual reality environment presenting a video mediated sexual experience. One path integrates HMD sensor data and one path integrates signal data from the DMU enabled input devices. Sensor data from the HMD captures head tracking data; the head tracking data may then be put through a smoothing algorithm; the head tracking data is used to control an audio controller; additional input data from the HMD is used as an input controller; head tracking data from the HMD is also used to provide control signals for a virtual reality camera controller; this data is collectively used to present virtual reality video and audio to the user on an HMD. In parallel, data is collected from a DMU enabled input device; the data may be put through one or more smoothing algorithms, the data from the input device is used to provide a control signal for a frame/frame rate controller for the video being played in the virtual environment; the data from the input device is also used as an audio controller to provide control signals for audio within the virtual environment; the data from the input device is also used as an input controller within the virtual environment. The result is an immersive virtual reality experience where users motions are captured by the DMU enabled input devices(s) and used to control simulated interactions within the virtual environment.

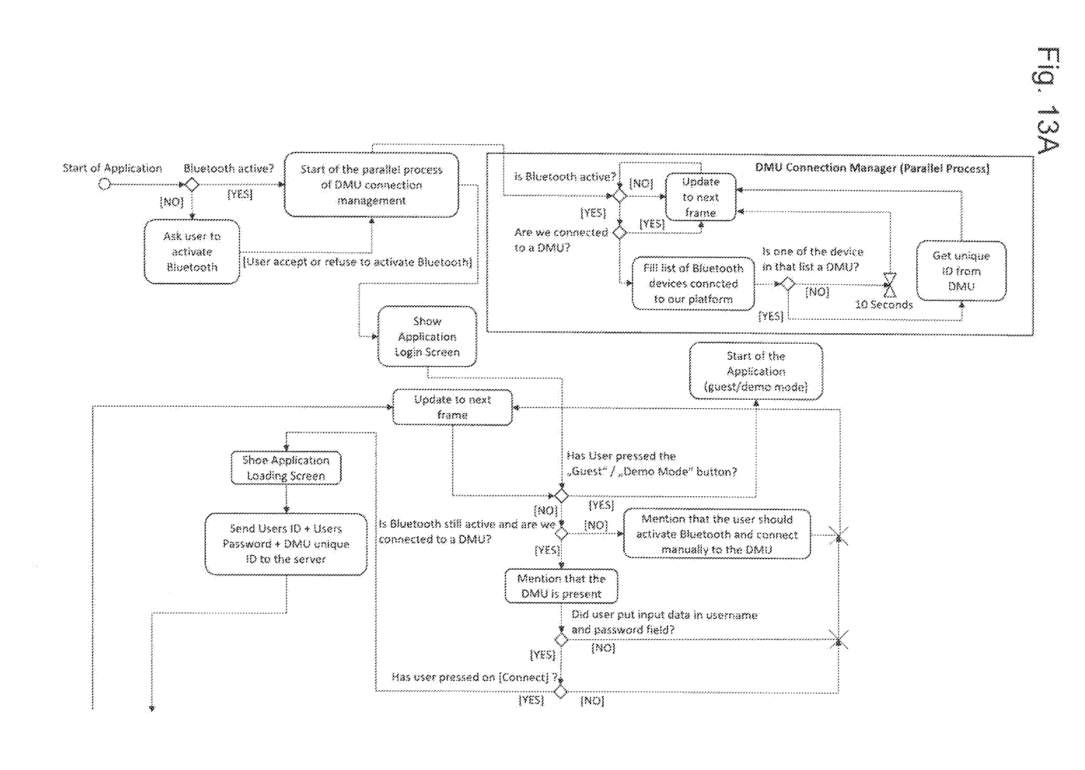

FIG. 12 shows a flow diagram illustrating the steps of a method used to present an interactive erotic experience to a user in virtual reality.

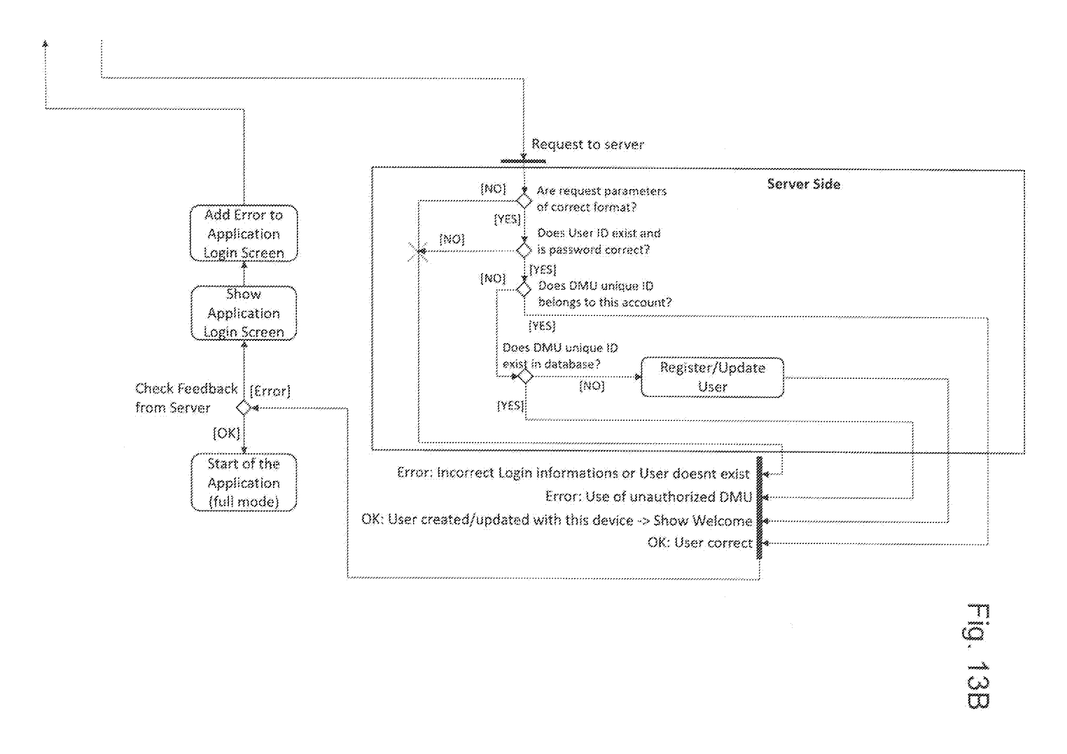

FIG. 13 shows a flow diagram illustrating the steps of a method used to present an interactive erotic experience to a user in virtual reality and in particular the way the movement of DMU enabled input device can be used to create a control signal for controlling interactive elements of the virtual environment.

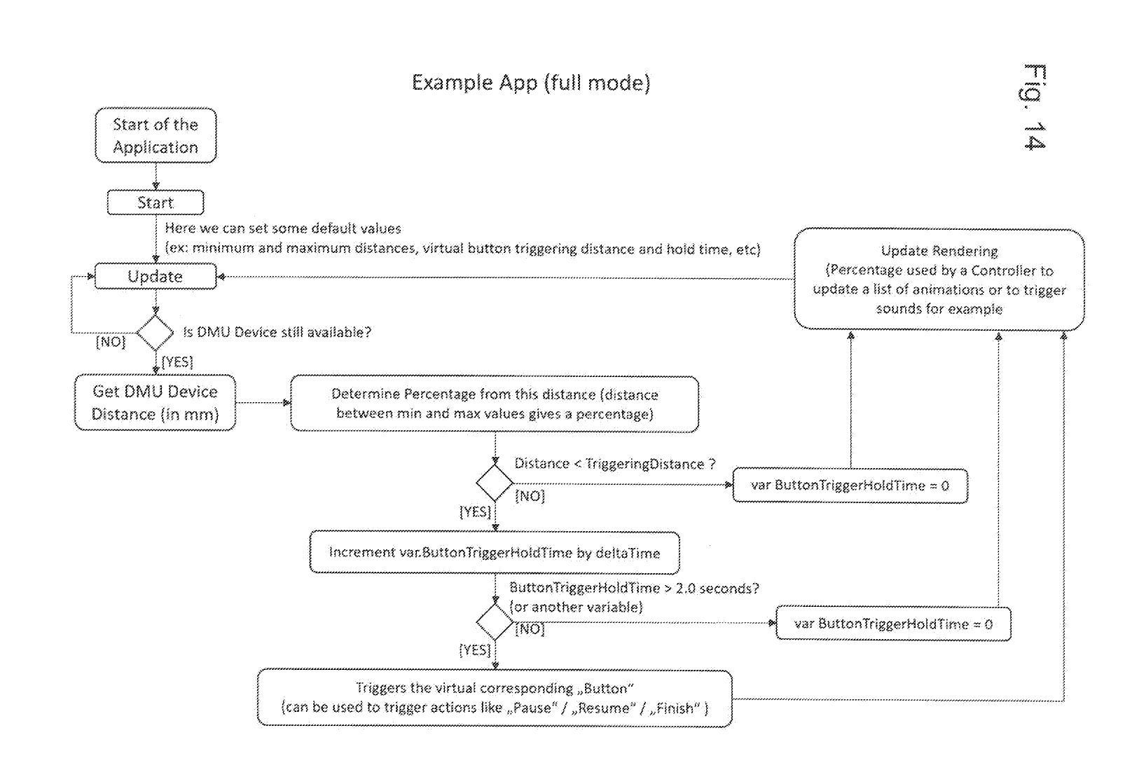

FIG. 14 shows a flow diagram illustrating the steps of a method used to present an interactive erotic experience to a user in virtual reality.

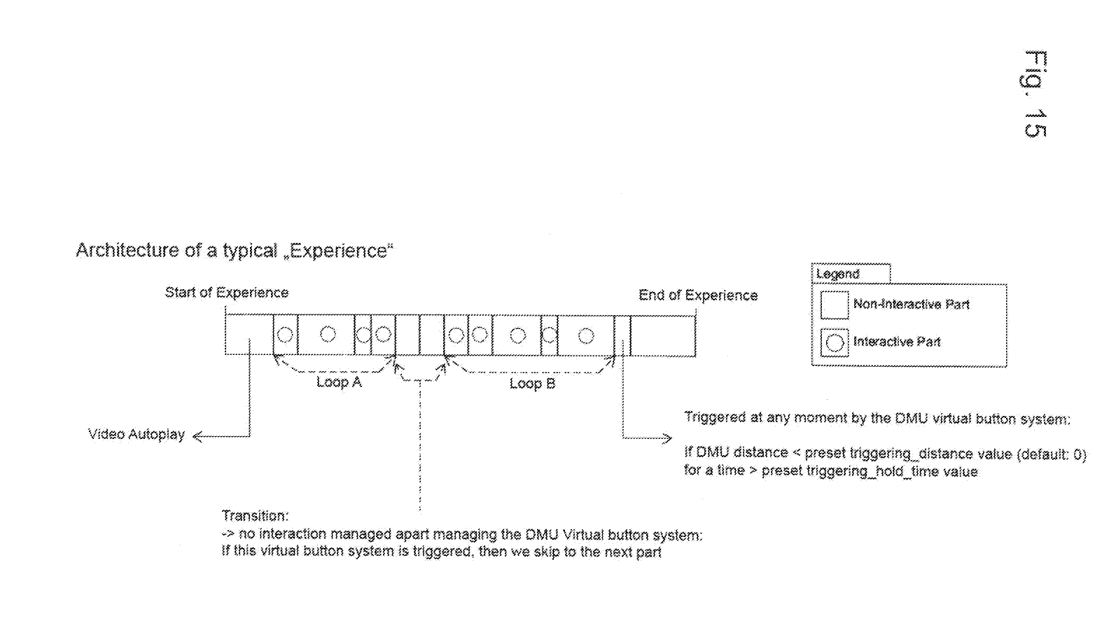

FIG. 15 shows the architecture of a typical experience using a DMU enabled input device to control interactions in a virtual reality environment.

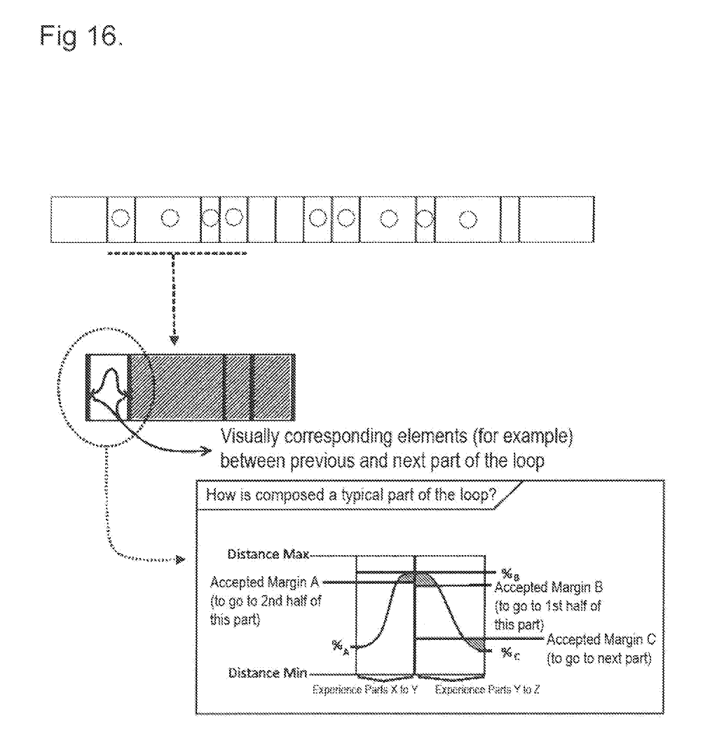

FIG. 16 shows a diagram illustrating the operation of looped video segments and their interaction with DMU enabled input devices.

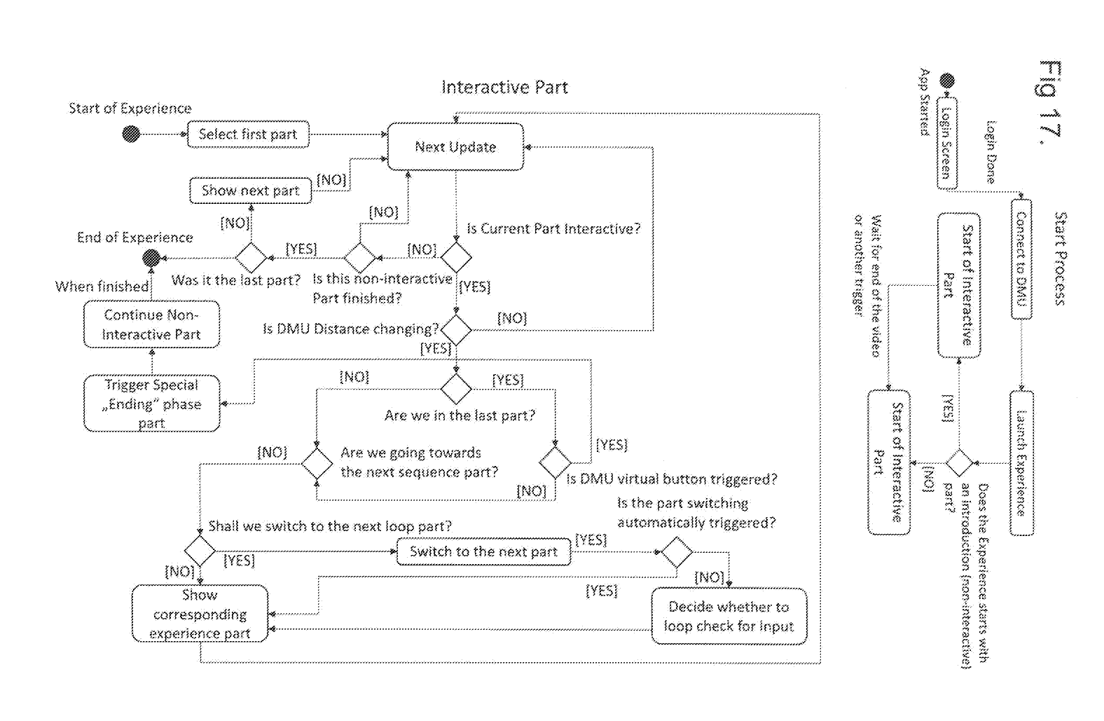

FIG. 17 shows a flow diagram illustrating the steps of a method used to present an interactive erotic experience to a user in virtual reality.

FIG. 18 shows a series of diagrams illustrating how user interactions with DMU enabled input devices are used to control interactions between a user's avatar and a virtual character present in a virtual environment.

FIG. 19 shows diagrams illustrating user interactions with DMU enabled input devices.

The above described embodiments of the present invention are presented for purposes of illustration and not of limitation, and the present invention is limited only by the claims which follow.

### LIST OF REFERENCE SIGNS

1 Ultrasonic Sensor

2 Microprocessor

3 Transmitter (Bluetooth transmitter for example)

4 Battery

5 Distance Measurement Unit

6 Female Sex Doll

7 Electromagnetic waves for wireless communication from transmitter

8 Ultrasonic waves for distance detection

9 Male Sex Doll

10 Augmented Reality Marker for Cameras

11 Rubber Vagina or so called Masturbator

12 Human Hand or Arm

13 Wristband

14 Two-axes rotatable connection between wristband and DMU

15 Rubber Penis, Dildo or Vibrator

16 Main PCB

17 Upper Case part

18 Lower Case part

19 One-Axis rotatable joint

20 Mounting member

21 Fixation Nodes

22 User

23 Head Mounted Display

24 Virtual Reality Application

25 Virtual Character

26 Users Avatar

27 Accelerometer

28 Magnetometer

29 Gyroscope

1.-14. (canceled)

15. A virtual reality system for promoting sexual health in users, the virtual reality system comprising a sexual interaction device for use as an input device for a virtual reality erotic application comprising a body part engaging portion and a distance measurement unit
wherein the distance measurement unit comprises an ultrasonic sensor assembly operatively coupled to the body part engaging portion and wherein the distance measurement unit comprises a transmitter using wireless technology for a transmission process,
the virtual reality system further comprising a computing device for receiving distance measurement data of the distance measurement unit and for controlling aspects of a virtual environment and/or interactions in the virtual environment based on the received distance measurement data.

16. The virtual reality system according to claim 15, wherein the body part engaging portion is a genital engaging portion or an arm engaging portion.

17. The virtual reality system according to claim 15, wherein the distance measurement unit comprises a mounting member, the mounting member comprising a two-axes rotatable portion.

18. The virtual reality system according to claim 15, wherein the distance measurement unit comprises a ball joint mounting member.

19. The virtual reality system according to claim 17, wherein the mounting member is constructed from a malleable material, preferably of a soft plastic, polysiloxane or rubber.

20. The virtual reality system according to claim 15, wherein the distance measurement unit comprises a unique identification chip with a unique identification number.

21. A method for providing an enhanced computer mediated sexual experience to a user, comprising the following steps
providing a virtual reality system according to claim 15;
presenting the user with a virtual reality environment;
accepting input from the user via a sexual interaction device of said virtual reality system; and
using the user's input from the sexual interaction device as a control signal for aspects of the virtual environment and/or interactions in the virtual environment.

22. The method according to claim 21, wherein the virtual reality environment comprises a video virtual reality environment with a video; and in that distance measurement data from the sexual interaction device is used for mapping a distance to certain frames inside of a loop of the video, in order to control which frame of the loop is to be shown to the user in dependence on the distance measurement data.

23. The method according to claim 22, wherein the loop of the video is changed to the next or previous loop if the distance measurement data is above an upper threshold or below a lower threshold.

24. The method according to claim 21, wherein the method further comprises following steps:
receiving a unique identification number from the distance measurement unit, the unique identification number being allocated to a specific distance measurement unit ;
comparing the unique identification number to a list of unique identification numbers to identify the specific distance measurement unit.

25. The method for providing an enhanced computer mediated sexual experience to a user , comprising the following steps
presenting the user with an augmented reality environment by projecting a virtual object in the person's real environment;
accepting input from the user via a sexual interaction device of a virtual reality system according to claim 15; and
using the user's input from the sexual interaction device as a control signal for aspects of the augmented reality environment and/or interactions in the augmented reality environment.

26. The use of a distance measurement unit comprising an ultrasonic sensor in a sexual interaction device suitable for use as an input device for a virtual reality and/or augmented reality erotic application.
